(19) United States
(12) Patent Application Publication
(10) Pub. No.: US 2023/0188762 A1
(43) Pub. Date: Jun. 15, 2023

(54) METHOD AND APPARATUS FOR PROCESSING LIVE ROOM TASK

(71) Applicant: BEIJING DAJIA INTERNET INFORMATION TECHNOLOGY CO., LTD., Beijing (CN)

(72) Inventors: Haowen ZHANG, Beijing (CN); Peiqiang TAN, Beijing (CN)

(21) Appl. No.: 17/883,820

(22) Filed: Aug. 9, 2022

(30) Foreign Application Priority Data
Dec. 14, 2021 (CN) 202111524756.2

(51) Int. Cl. H04N 21/2187; H04N 21/478

(52) U.S. Cl. CPC H04N 21/2187; H04N 21/478

(57) ABSTRACT

The present disclosure relates to a method and apparatus for processing a live room task, a server and a storage medium. The method includes: acquiring task information of a live room task in a case where a live room has the live room task, wherein the task information includes a task data indicator of the live room task and target live room data matching the task data indicator; acquiring real-time live room data matching the task data indicator in the live room; and obtaining a task processing status of the live room task according to the real-time live room data and the target live room data.

### CROSS REFERENCE

The present application claims the benefit of priority to Chinese Application No. 202111524756.2, filed on Dec. 14, 2021, the contents of which are incorporated herein by reference in their entireties for all purposes.

### TECHNICAL FIELD

The present disclosure relates to the field of live streaming technologies, and in particular, to a method and apparatus for processing a live room task, a server and a storage medium.

### BACKGROUND

With the development of live streaming technologies, there has been a business that motivates an anchor through an anchor task. When the anchor performs a live streaming, the anchor can obtain a corresponding virtual resource as a reward by completing a set anchor task.

In the related art, the set anchor task can typically comprise multiple task conditions, such as the number of likes from audiences, a duration of the live streaming, and the number of rewards from the audiences, etc. When all the task conditions are met, the anchor task is completed.

### SUMMARY

The present disclosure provides a method and apparatus for processing a live room task, a server and a storage medium.

According to a first aspect of the embodiments of the present disclosure, there is provided a method for processing a live room task, and the method includes:

acquiring task information of a live room task in a case where a live room has the live room task, wherein the task information includes a task data indicator of the live room task, and target live room data matching the task data indicator;

acquiring real-time live room data matching the task data indicator in the live room; and

obtaining a task processing status of the live room task according to the real-time live room data and the target live room data.

According to a second aspect of the embodiments of the present disclosure, there is provided an apparatus for processing a live room task, and the apparatus includes:

a task information acquisition unit, configured to acquire task information of a live room task in a case where a live room has the live room task, wherein the task information includes a task data indicator of the live room task, and target live room data matching the task data indicator;

a real-time data acquisition unit, configured to acquire real-time live room data matching the task data indicator in the live room; and

a task status determination unit, configured to obtain a task processing status of the live room task according to the real-time live room data and the target live room data.

According to a third aspect of the embodiments of the present disclosure, there is provided a server, including: a processor; and a memory configured to store executable instructions of the processor; wherein, the processor is configured to execute the instructions to implement the method for processing the live room task according to any one of the embodiments of the first aspect.

According to a fourth aspect of the embodiments of the present disclosure, there is provided a computer-readable storage medium, wherein instructions in the computer-readable storage medium, when executed by a processor of a server, cause the server to execute the method for processing the live room task according to any one of the embodiments of the first aspect.

According to a fifth aspect of the embodiments of the present disclosure, there is provided a computer program product including instructions, wherein the instructions, when executed by a processor of a server, cause the server to execute the method for processing the live room task according to any one of the embodiments of the first aspect.

It should be noted that the above general description and the following detailed description are merely exemplary and explanatory and should not be construed as limiting of the disclosure.

### BRIEF DESCRIPTION OF THE DRAWINGS

The accompanying drawings here, which are incorporated into and constitute a part of the present disclosure, illustrate embodiments consistent with the present disclosure and, together with the description, serve to explain principles of the present disclosure, and do not expose any improper limitation on the present disclosure.

FIG. 1 is a diagram showing an application environment of a method for processing a live room task according to an embodiment of the present disclosure.

FIG. 2 is a flowchart showing a method for processing a live room task according to an embodiment of the present disclosure.

FIG. 3 is a flowchart showing obtaining a task processing status of a live room task according to an embodiment of the present disclosure.

FIG. 4 is a flowchart showing acquiring real-time live room data according to an embodiment of the present disclosure.

FIG. 5 is a flowchart showing a method for implementing a multi-condition task in a live room according to an embodiment of the present disclosure.

FIG. 6 is a block diagram showing an apparatus for processing a live room task according to an embodiment of the present disclosure.

FIG. 7 is a block diagram showing an electronic device according to an embodiment of the present disclosure.

### DETAILED DESCRIPTION

In order to make a person skilled in the art better understand the technical solutions of the present disclosure, the following clearly and completely describes the technical solutions in embodiments of the present disclosure with reference to the accompanying drawings.

It should be noted that in the specification, claims, and accompanying drawings of the present disclosure, the terms “first”, “second”, and so on are intended to distinguish similar objects but do not necessarily indicate a specific order or sequence. It is to be understood that data termed in such a way is interchangeable in proper circumstances, so that the embodiments of the present disclosure described herein may be implemented in other sequences than the sequence illustrated or described herein. The implementations set forth in the following description of the embodiments do not represent all implementations consistent with the present disclosure. Instead, they are merely examples of apparatuses and methods consistent with some aspects related to the present disclosure as recited in the appended claims.

It should also be noted that user information (including but not limited to user device information, user personal information, etc.) and data (including but not limited to display data, analysis data, etc.) involved in the present disclosure are information and data authorized by a user or fully authorized by various parties.

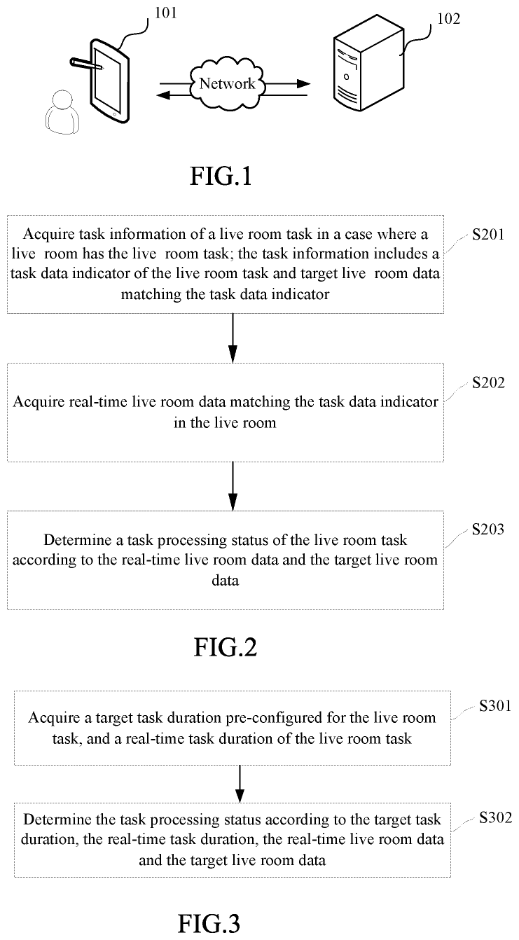

A method for processing a live room task provided by the present disclosure can be applied to an application environment shown in FIG. 1. A terminal 101 is in interaction with a server 102 through a network. Specifically, an anchor account can enter its corresponding live room through the terminal 101, and perform a live streaming through the live room. The server 102 can then determine whether the live room carries a corresponding live room task, and if the live room carries the live room task, the server 102 can also obtain task information of the live room task, the task information including a task data indicator of the live room task and target live room data matching the task data indicator. In addition, the server 102 can also acquire corresponding real-time live room data in the live room according to the task data indicator, and determine a task processing status of the live room task based on the acquired target live room data and real-time live room data. The terminal 101 can be, but is not limited to, various personal computers, laptops, smart phones, tablet computers, and portable wearable devices. The server 102 can be implemented by an independent server or a server cluster composed of multiple servers.

FIG. 2 is a flowchart showing a method for processing a live room task according to an embodiment of the present disclosure. As shown in FIG. 2, the method for processing the live room task is applied to the server 102 and includes the following steps S201 to S203.

In the step S201, in response to a live room having a live room task, task information of the live room task is acquired, and the task information includes a task data indicator of the live room task, and target live room data matching the task data indicator.

The live room task refers to a preset anchor task used to motivate an anchor account in the live room to complete the same during a live streaming process. The task information refers to relevant information of the live room task, and the task information can be a completion condition of the live room task, which can be composed of two parts of a data indicator corresponding to a task condition of a task that needs to be performed, that is, the task data indicator, and a target value that the data indicator needs to achieve, that is, the target live room data matching the task data indicator. For example, a completion condition of a certain live room task is that the number of likes needs to reach 100, and then the task data indicator refers to a number of likes indicator, 100 indicates the target live room data matching the task data indicator; and if the completion condition of the certain live room task is that the number of comments from audience accounts reaches 50, then the task data indicator is a number of comments indicator, and 50 indicates the target live room data matching the task data indicator.

Specifically, the server 102 can screen out the live room carrying the live room task from a plurality of live rooms that are conducting live streaming events, and if a certain live room carries the live room task, the server 102 can also acquire the task information corresponding to the live room task. The task information corresponding to the live room task can be acquired from a background database that stores task information of individual live room tasks in advance.

In the step S202, real-time live room data matching the task data indicator in the live room is acquired.

The real-time live room data refers to real-time data, among real-time data of the live room, that matches the task data indicator. After the task data indicator of the live room task carried by the live room is determined in the step S201, the real-time live room data that matches the task data indicator can be acquired. The server 102 can collect the real-time live room data in real time. Alternatively, a background server can perform accumulation of the real-time data of the live room to obtain the real-time live room data, and then the server 102 obtains the real-time live room data from the background database. For example, the task data indicator determined in the step S201 is the number of likes indicator, the server 102 can obtain the real-time number of likes information of the live room as the real-time live room data; and if the task data indicator determined in the step S201 is the number of comments indicator, the server 102 can obtain the real-time number of comments information of the live room as the real-time live room data.

In the step S203, a task processing status of the live room task is obtained according to the real-time live room data and the target live room data.

The task processing status indicates a real-time status of the live room task, which, for example, may include the task being in progress, the task having been completed, etc. After the server 102 obtains the target live room data and the real-time live room data matching the task data indicator, respectively, it can further determine the real-time status of the live room task, that is, the task processing status of the live room task according to the target live room data and the real-time live room data. For example, the target live room data matching the task data indicator can be 100 likes, and in a case where the real-time live room data corresponding to the number of likes in the live room has reached 100, it means that the live room task has been completed, that is, the task processing status of the live room task is that the task is completed.

In the above-mentioned method for processing the live room task, in the case where the live room has the live room task, the task information of the live room task is acquired, and the task information includes the task data indicator of the live room task, and the target live room data matching the task data indicator; the real-time live room data matching the task data indicator is acquired; and the task processing status of the live room task is obtained according to the real-time live room data and the target live room data. The present disclosure can determine the processing status of the live room task by acquiring the task data indicator of the live room task and the corresponding target data from the task information of the live room task, and comparing with the real-time data matching the task data indicator in the live room, which realizes a real-time update of the status of the live room task, and improves the real-time performance of the method for processing the live room task.

In an embodiment, as shown in FIG. 3, the step S203 may further include steps S301 to S302.

In the step S301, a target task duration pre-configured for the live room task and a real-time task duration of the live room task are acquired.

The target task duration refers to a maximum task duration preset for the live room task, and the real-time task duration refers to an actual execution duration of the live room task by the current time. In this embodiment, the task duration of the live room task is not unlimited, but has a set threshold. When the task duration of the live room task reaches the set threshold, it means that the live room task is over. After acquiring the task information of the live room task, the server 102 can also acquire the maximum task duration corresponding to the live room task as the target task duration, and can further count a real-time execution duration of the live room task as the real-time task duration. For example, for a certain live room task, the task is configured with the maximum duration of 30 minutes, and the task has been conducted for 20 minutes, the 30 minutes is the target task duration of the live room task, and the 20 minutes is the real-time task duration of the live room task.

In the step S302, the task processing status is obtained according to the target task duration, the real-time task duration, the real-time live room data and the target live room data.

After acquiring the target task duration and the real-time task duration in the step S301, the server 102 can further use the target task duration and the real-time task duration, as well as the target live room data and the real-time live room data obtained in the steps S201 and S202 respectively, to determine the task processing status of the live room task.

In this embodiment, the target task duration for the live room task can also be set to avoid infinite extension of the live room task, thereby further improving the intelligence of processing the live room task.

Further, the number of task data indicators is multiple; and the step S302 may further include: determining that the task processing status is “successful” in a case where the real-time task duration of the live room task is not longer than the target task duration, and real-time live room data respectively matching individual task data indicators is not smaller than target live room data respectively matching the individual task data indicators; and/or determining that the task processing status is “in progress” in a case where the real-time task duration of the live room task is not longer than the target task duration, and real-time live room data matching any task data indicator is smaller than target live room data matching the task data indicator.

In this embodiment, the number of task data indicators may also be multiple. For the certain live room task, it has multiple completion conditions. For example, for a live room task A, its completion conditions that need to be satisfied are that the number of likes reaches 100, and the number of shares reaches 50, and for another live room task B, its completion conditions that need to be satisfied can be that the number of shares reaches 100 and the number of user comments reaches 50. It can be seen that the live room task has the multiple completion conditions, and accordingly, the task information of the live room task can also include the multiple task data indicators. That is, for the live room task A, its corresponding task data indicators can be the number of likes indicator and the number of shares indicator, and the target live room data matching respective task data indicators is 100 likes and 50 shares, respectively; and for the live room task B, its corresponding task data indicators can be the number of shares indicator and the number of comments indicator, and the target live room data matching respective task data indicators is 100 shares and 50 comments, respectively.

Specifically, the server 102 can determine individual task data indicators of the live room task in the live room, and the target live room data matching individual task data indicators, respectively, and can also acquire the real-time live room data matching individual task data indicators, respectively. The task processing status of the live room task is determined through the target live room data and the real-time live room data of individual task data indicators.

In an embodiment of the present disclosure, when the real-time live room data of each task data indicator is not smaller than the target live room data of the corresponding task data indicator, it means that all the completion conditions of the task have been satisfied, and since the real-time task duration of the live room task at this time is not longer than the target task duration, that is, the live room task has not timed out, the server 102 can determine that the live room task ends at this time, and also determine that the task processing status is “successful”. If the real-time live room data of any task data indicator is smaller than the target live room data of the corresponding task data indicator, it means that one of the completion conditions of the task is not satisfied, and since the real-time task duration of the live room task at this time is not longer than the target task duration, that is, the live room task has not timed out, it indicates that the live room task still continues being processed, and the server 102 can determine that the task processing status at this time is “in progress”.

In this embodiment, when the number of task data indicators is multiple, the server 102 may compare the real-time live room data of each task data indicator with the target live room data of the corresponding task data indicator, and compare the target task duration of the live room task with the real-time task duration of the live room task, and then determine the task processing status of the live room task based on the above comparison results, which realizes the determination of the real-time status of the multi-condition live room task, and further improves scalability of the determination of the status of the live room task.

Furthermore, after it is determined that the task processing status is “successful”, the method may further include: acquiring a virtual resource corresponding to the live room task, and allocating the virtual resource to an anchor client of the live room matching the live room task.

The virtual resource refers to a resource used for feeding back to the anchor client after the live room task is completed. In this embodiment, the live room task may be preset with the corresponding virtual resource, and after determining that the task processing status of the live room task is “successful”, that is, the live room task has been successfully completed, the server 102 may acquire the corresponding virtual resource, and return the virtual resource to the anchor client of the anchor account corresponding to the live room.

In this embodiment, for the live room task whose task processing status is “successful”, the server 102 may also acquire the virtual resource adaptable for the live room task, and allocate the virtual resource to the anchor client of the live room matching the live room task, which realizes the intelligent allocation of the virtual resource, so as to realize the incentive for the anchor, and then improve the enjoyment of the live streaming program.

In addition, the step S302 may further include: determining that the task processing status is “failed” in a case where the real-time task duration of the live room task is longer than the target task duration.

If the real-time task duration of the live room task is longer than the target task duration, it means that the live room task has timed out, and the server 102 can also determine that the live room task of the live room is failed while determining that the live room task ends. That is, the server 102 determines that the task processing status of the live room task is that the task processing fails.

In this embodiment, if the live room task has timed out, the server 102 may also set the task processing status of the live room task as the failed task processing while determining that the live room task ends, thereby improving the completeness of processing status information of the live room task.

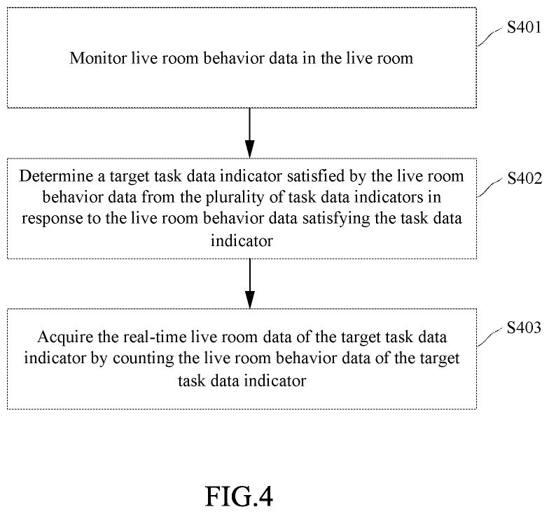

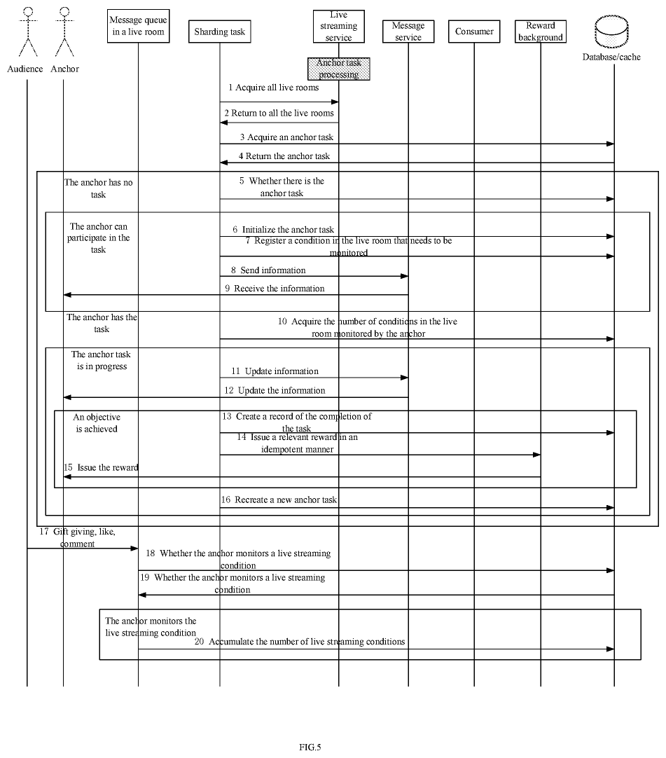

In an embodiment, the number of task data indicators is multiple; and as shown in FIG. 4, the step S202 may further include steps S401 to S403.

In the step S401, live room behavior data in the live room is monitored.

The live room behavior data refers to behavior data triggered by an account, which can be the anchor account or the audience account, in the live room, which, for example, may be a certain account giving the like on the live room, a certain account giving the comment in the live room or a certain account performing a sharing operation in the live room, etc. In this embodiment, the server 102 can monitor various live room behavior data in the live room in real time, for example, it can monitor the live room behavior data in real time through a consumer consuming live room information.

In the step S402, in a case where the live room behavior data satisfies the task data indicator, a target task data indicator satisfied by the live room behavior data is determined from the plurality of task data indicators.

The target task data indicator refers to a task data indicator, among the multiple task data indicator, satisfied by each piece of live room behavior data. Since some of the live room behavior data monitored by the server 102 may not belong to the behavior data that matches the task data indicator. For example, the live room behavior data includes data of an account's liking behavior in the live room, and if the task data indicator does not include the number of likes indicator, the live room behavior data does not satisfy the task data indicator, and the server 102 also does not need to count the live room behavior data. Therefore, after the server 102 monitors the live room behavior data in the step S401, whether the monitored live room behavior data satisfies the task data indicator of the live room task carried by the live room can also first determined. For example, the server 102 can acquire the task data indicator that needs to be monitored from the background database through the consumer, and determine whether the live room behavior data satisfies the task data indicator of the live room task carried by the live room when monitoring the live room behavior data.

However, in a case where the server 102 determines that the live room behavior data satisfies the task data indicator, the server 102 can further determine the target task data indicator satisfied by the live room behavior data, that is, determine the corresponding target task data indicator from the plurality of task data indicators. For example, the live room behavior data is a certain account giving a comment, and if the live room task of the live room includes two task data indicators of the number of comments indicator and the number of shares indicator, the server 102 can determine the task data indicator satisfied by the behavior data, that is, the target task data indicator is the number of comments indicator.

In the step S403, the real-time live room data of the target task data indicator is obtained by counting the live room behavior data of the target task data indicator.

After determining the target task data indicator in the step S402, the server 102 may further perform statistics on the live room behavior data of the target task data indicator. The server 102 can directly perform statistics on the live room behavior data of the target task data indicator. Alternatively, accumulation processing is performed on the live room behavior data of the target task data indicator through the consumer, the accumulated result is stored in the background database, and the server 102 reads the accumulated result from the background database to obtain the real-time live room data of the target task data indicator.

In this embodiment, the server 102 may also monitor the live room behavior data in the live room, and perform statistics on the live room behavior data of each task data indicator by screening out the live room behavior data that satisfies the task data indicator and determining the task data indicator corresponding to each piece of live room behavior data that satisfies the task data indicator, so that the task data indicator included in the live room task can be flexibly expanded, and the flexibility of processing the live room task is improved.

In addition, the method for processing the live room task may further include: displaying target live room data respectively matching individual task data indicators and real-time live room data respectively matching the individual task data indicators in the live room.

In this embodiment, after obtaining the target live room data and the real-time live room data that match the individual task data indicators of the live room task, respectively, the server 102 can further display the target live room data and the real-time live room data in the live room. A live room pendant carried in the live room can be used, and the target live room data and the real-time live room data can be displayed through the pendant. For example, the target live room data corresponding to the live room task may be 100 likes and 50 shares, while the real-time live room data at this time may be 75 likes and 40 shares, the server 102 can display the above data in the live room through the live room pendant, that is, 100 likes, 50 shares, 75 likes, and 40 shares are displayed in the live room to inform the account in the live room about a task progress of the live room task.

In this embodiment, the server 102 can also display, in the live room, the target live room data and the real-time live room data that match the individual task data indicators of the live room task carried by the live room, respectively, so that the account in the live room can be informed about the task progress of the live room task, thereby improving the visibility of the progress of the live room task.

In an embodiment, before the step S201, the method may further include: in response to a live streaming request of live room, in a case where a live room matching the live streaming request of live room does not carry a live room task in advance, acquiring matched task information according to an acquired live room task creation instruction; and creating a live room task matching the live room according to the matched task information.

The live streaming request of live room refers to a request triggered by the anchor account to initiate a live streaming event through its live room. When the anchor account needs to conduct the live streaming through the live room, it can use its terminal 101 to initiate the live streaming request of live room for the live room of the anchor account to the server 102. The server 102 may respond to the live streaming request, determine the live room matching the live streaming request, and detect whether the live room has already carried the live room task in advance.

However, if the live room does not carry the live room task in advance, the server 102 may further perform a process of acquiring the live room task creation instruction, and the instruction may be an instruction triggered by the anchor account and used to create the live room task. For example, the server 102 can confirm that the live room does not carry the live room task in advance, and the server 102 can return a notification message to the terminal 101 of the anchor account. The notification message can carry two options, which respectively represent creating the live room task and not creating the live room task. The anchor account can select the options through the terminal 101, and if the option selected by the anchor account represents the creating the live room task, the terminal 101 can generate a corresponding live room creation instruction and return it to the server 102. After obtaining the live room creation instruction, the server 102 can further obtain the task information matching the live room task. For example, a task completion condition of the live room task can be registered, that is, the task data indicator included in the live room task and the target value matching each task data indicator are registered as the target live room data. In addition, the task information matching the live room task is stored in the background database, so as to realize that the live room task matching the live room task information is created for the live room.

Meanwhile, if the server 102 determines that the live room has already carried the live room task in advance, it does not execute the process of creating the live room task, but directly executes the step S201, that is, the step of acquiring the task information of the live room task.

In the above-mentioned embodiment, when the live streaming starts to be conducted in the live room, the server 102 can also detect whether the live room where the live streaming is being conducted carries the live room task in advance. If the live room does not carry the live room task, the server 102 can further acquire the task information corresponding to the task according to the obtained live room task creation instruction to realize the creation of the live room task, so that the creation efficiency of the live room task can be improved.

In an embodiment, there is also provided a method for implementing a multi-condition anchor task in a live room. When the anchor starts to conduct the live streaming, whether there is an ongoing anchor task in the current live room is scanned. If not, it is determined whether to initialize the anchor task. For the live room having the anchor task, the behavior in the live room that needs to be monitored is set, such as gift giving, likes, and comments. When a viewer passing a condition of a downstream live room views messages of all the live rooms, it is determined whether there is the anchor task according to an anchor number in the message, and then the accumulation is performed. An upstream task scanning determines whether to continue the task or to complete the delivery of the virtual resource according to a task value of the condition in the live room of the anchor having the anchor task, so as to realize a status flow of the multi-condition anchor task in the live room. As shown in FIG. 5, the method may specifically include the following steps:

1. when the anchor starts to conduct the live streaming, it is determined whether there is the anchor task. If not, it is determined whether to create the anchor task. After the anchor task is initialized, a condition required for the completion of the anchor task is written into the cache.

2. it is determined whether there is a need to monitor a consumer of a relevant condition acquiring the current anchor from the cache, and if so, the accumulation is performed according to a task number.

3. task scan is performed with respect to a plurality of live rooms, the anchor having the task is screened out, and the task value of each condition is acquired from the cache according to conditions required by the task. If the task value needs to be displayed to the live room, the task value is displayed to the live room through the widgets.

4. if the multiple conditions of the task are met, the relevant virtual resource will be issued, and it is determined whether a task of the next cycle needs to be created immediately. If not, the current task continues to be scanned, and otherwise, the task of the next cycle is initialized.

In this embodiment, through scanning task, the transfer of the task status can be converged to one place, idempotent processing is performed on the status in change of the entire task, and a monitoring logic of the condition of the live room task can be asynchronously decoupled, a set of conditions of the live room task monitored by the live room can be flexibly expanded.

It should be understood that although various steps in the flowcharts of FIG. 1 to FIG. 5 are sequentially displayed as indicated by arrows, these steps are not necessarily sequentially performed in an order indicated by these arrows. Unless otherwise clearly specified in the present specification, these steps are performed without any strict sequence limit, and may be performed in other orders. In addition, at least some steps in FIG. 1 to FIG. 5 may include a plurality of steps or a plurality of stages, and these steps or stages are not necessarily performed at a same time instant, but may be performed at different time instants. The steps or stages are not necessarily performed in sequence, and the steps or stages may be performed alternately with at least some of steps or stages of other steps.

It can be understood that, the same/similar parts among the various embodiments of the above methods in this specification can be referred to each other, and each embodiment focuses on the points that are different from other embodiments, and for related parts, reference can be made to the description of other method embodiments.

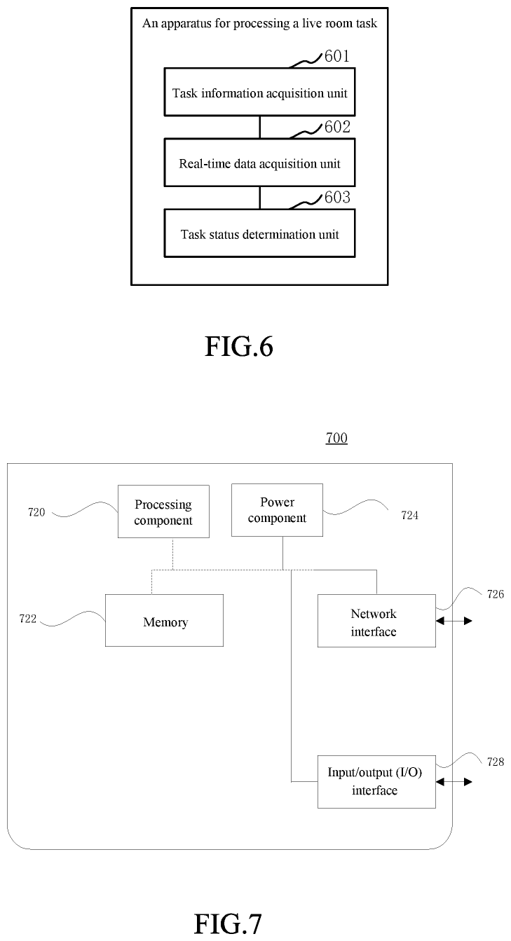

FIG. 6 is a block diagram showing an apparatus for processing a live room task according to an embodiment of the present disclosure. Referring to FIG. 6, the apparatus includes a task information acquisition unit 601, a real-time data acquisition unit 602 and a task status determination unit 603.

The task information acquisition unit 601 is configured to acquire task information of a live room task in a case where a live room has the live room task, and the task information includes a task data indicator of the live room task and target live room data matching the task data indicator;

the real-time data acquisition unit 602 is configured to acquire real-time live room data matching the task data indicator in the live room; and

the task status determination unit 603 is configured to obtain a task processing status of the live room task according to the real-time live room data and the target live room data.

In an embodiment, the task status determination unit 603 is further configured to acquire a target task duration pre-configured for the live room task, and a real-time task duration of the live room task; and obtain the task processing status according to the target task duration, the real-time task duration, the real-time live room data and the target live room data.

In an embodiment, the task information includes a plurality of task data indicators; and the task status determination unit 603 is further configured to: determine that the task processing status is successful in a case where the real-time task duration of the live room task is not longer than the target task duration, and target live room data respectively matching individual task data indicators is not smaller than real-time live room data respectively matching the individual task data indicators; and determine that the task processing status is in progress in a case where the real-time task duration of the live room task is not longer than the target task duration, and target live room data matching any task data indicator is smaller than real-time live room data matching the task data indicator.

In an embodiment, the apparatus for processing the live room task further includes: a virtual resource allocation unit, configured to acquire a virtual resource corresponding to the live room task, and allocate the virtual resource to an anchor client of the live room matching the live room task.

In an embodiment, the task status determining unit 603 is further configured to determine that the task processing status is failed in a case where the real-time task duration of the live room task is longer than the target task duration.

In an embodiment, the number of task data indicators is multiple; and the real-time data acquisition unit 602 is further configured to monitor live room behavior data in the live room; determine a target task data indicator satisfied by the live room behavior data from the plurality of task data indicators in response to the live room behavior data satisfying the task data indicator; and acquire the real-time live room data of the target task data indicator by counting the live room behavior data of the target task data indicator.

In an embodiment, the apparatus for processing the live room task further includes: a live streaming data display unit, configured to display target live room data respectively matching individual task data indicators and real-time live room data respectively matching the individual task data indicators in the live room.

In an embodiment, the apparatus for processing the live room task further includes: a live streaming task creation unit, configured to, in response to a live streaming request of live room, acquire matched task information according to an acquired live room task creation instruction, in a case where a live room matching the live streaming request of live room does not have the live room task in advance, and create the live room task matching the live room according to the matched task information.

Regarding the apparatus in the above-mentioned embodiments, a specific manner in which each module performs operations has been described in detail in the method embodiments and will not be described in detail here.

FIG. 7 is a block diagram showing an electronic device 700 for processing a live room task according to an embodiment of the present disclosure. For example, the electronic device 700 may be a server. Referring to FIG. 7, the electronic device 700 includes a processing component 720, which further includes one or more processors and a memory resource represented by a memory 722 for storing instructions executable by the processing component 720, such as an application program. The application program stored in the memory 722 may include one or more modules, each corresponding to a set of instructions. In addition, the processing component 720 is configured to execute the instructions to execute the aforementioned methods.

The electronic device 700 may also include: a power component 724 configured to perform power management of the electronic device 700, a wired or wireless network interface 726 configured to connect the electronic device 700 to the network, and an input/output (I/O) interface 728. The electronic device 700 may operate an operating system stored in the memory 722, such as Windows Server™, Mac OS X™, Unix™, Linux™, FreeBSD™, or the like.

In an embodiment, there is also provided a computer-readable storage medium including instructions, such as the memory 722 including instructions, the above instructions may be executed by the processor of the electronic device 700 for performing the above-described methods. The storage medium may be a computer-readable storage medium, for example, the computer-readable storage medium may be a ROM, a Random Access Memory (RAM), a CD-ROM, a magnetic tape, a floppy disc, an optical data storage device, and the like.

In an embodiment, there is also provided a computer program product including instructions, and the instructions can be executed by the processor of the electronic device 700 to complete the above-mentioned method.

It should be noted that the descriptions of the apparatus, the electronic device, the computer-readable storage medium, the computer program product, etc. according to the method embodiments may also include other implementations. For the specific implementations, reference may be made to the descriptions of the related method embodiments, which will not be repeated here.

Other embodiments of the present disclosure will be apparent to those skilled in the art from consideration of the specification and practice of the present disclosure disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

It should be understood that the present disclosure is not limited to the precise structures that have been described above and shown in the drawings, and various modifications and changes can be made without departing from the scope thereof. The scope of the present disclosure is limited only by the appended claims.

1. A method for processing a live room task, comprising:
acquiring task information of the live room task in a case where a live room has the live room task, wherein the task information comprises a task data indicator of the live room task and target live room data matching the task data indicator;
acquiring real-time live room data matching the task data indicator in the live room; and
determining a task processing status of the live room task according to the real-time live room data and the target live room data.

2. The method according to claim 1, wherein said determining the task processing status of the live room task according to the real-time live room data and the target live room data comprises:
acquiring a target task duration pre-configured for the live room task, and a real-time task duration of the live room task; and
determining the task processing status according to the target task duration, the real-time task duration, the real-time live room data and the target live room data.

3. The method according to claim 2, wherein the task information comprises a plurality of task data indicators; and
said determining the task processing status according to the target task duration, the real-time task duration, the real-time live room data and the target live room data comprises:
determining that the task processing status is successful in a case where the real-time task duration of the live room task is not longer than the target task duration, and real-time live room data respectively matching individual task data indicators is not smaller than target live room data respectively matching the individual task data indicators; and/or
determining that the task processing status is in progress in a case where the real-time task duration of the live room task is not longer than the target task duration, and real-time live room data matching any task data indicator is smaller than target live room data matching the task data indicator.

4. The method according to claim 3, wherein the method further comprises:
acquiring a virtual resource corresponding to the live room task, and allocating the virtual resource to an anchor client of the live room in response to determining that the task processing status is successful.

5. The method according to claim 2, wherein said determining the task processing status according to the target task duration, the real-time task duration, the real-time live room data and the target live room data comprises:
determining that the task processing status is failed in a case where the real-time task duration of the live room task is longer than the target task duration.

6. The method according to claim 1, wherein the task information comprises a plurality of task data indicators; and
said acquiring the real-time live room data matching the task data indicator in the live room comprises:
monitoring live room behavior data in the live room;
determining a task data indicator which the live room behavior data satisfies from the plurality of task data indicators; and
acquiring the real-time live room data of the task data indicator by counting the live room behavior data of the task data indicator.

7. The method according to claim 6, wherein the method further comprises:
displaying target live room data respectively matching individual task data indicators and real-time live room data respectively matching the individual task data indicators in the live room.

8. The method according to claim 1, wherein in a case where the live room does not have the live room task in advance, the method further comprises:
acquiring live room task creation instruction and task information matching the live room task creation instruction, in response to a live streaming request of the live room; and
creating the live room task matching the live room according to the task information.

9. A server, comprising:
a processor; and
a memory configured to store executable instructions of the processor;
wherein the processor is configured to execute the instructions to implement the following operations:
acquiring task information of a live room task in a case where a live room has the live room task, wherein the task information comprises a task data indicator of the live room task and target live room data matching the task data indicator;
acquiring real-time live room data matching the task data indicator in the live room; and
determining a task processing status of the live room task according to the real-time live room data and the target live room data.

10. The server according to claim 9, wherein the processor is further configured to:
acquire a target task duration pre-configured for the live room task, and a real-time task duration of the live room task; and
determine the task processing status according to the target task duration, the real-time task duration, the real-time live room data and the target live room data.

11. The server according to claim 10, wherein the task information comprises a plurality of task data indicators; and
the processor is further configured to:
determine that the task processing status is successful in a case where the real-time task duration of the live room task is not longer than the target task duration, and real-time live room data respectively matching individual task data indicators is not smaller than target live room data respectively matching the individual task data indicators; and
determine that the task processing status is in progress in a case where the real-time task duration of the live room task is not longer than the target task duration, and real-time live room data matching any task data indicator is smaller than target live room data matching the task data indicator.

12. The server according to claim 11, wherein the processor is further configured to acquire a virtual resource corresponding to the live room task, and allocate the virtual resource to an anchor client of the live room in response to determining that the task processing status is successful.

13. The server according to claim 10, wherein the processor is further configured to determine that the task processing status is failed in a case where the real-time task duration of the live room task is longer than the target task duration.

14. The server according to claim 9, wherein the task information comprises a plurality of task data indicators; and
the processor is further configured to:
monitor live room behavior data in the live room;
determine a task data indicator which the live room behavior data satisfies from the plurality of task data indicators; and
acquire the real-time live room data of the task data indicator by counting the live room behavior data of the task data indicator.

15. The server according to claim 14, wherein the processor is further configured to display target live room data respectively matching individual task data indicators and real-time live room data respectively matching the individual task data indicators in the live room.

16. The server according to claim 9, wherein in a case where the live room does not have the live room task in advance, the processor is further configured to:
acquire live room task creation instruction and task information matching the live room task creation instruction, in response to a live streaming request of the live room; and
create the live room task matching the live room according to the task information.

17. A non-transitory computer-readable storage medium, wherein instructions in the non-transitory computer-readable storage medium, when executed by a processor of a server, cause the server to execute the following operations:
acquiring task information of a live room task in a case where a live room has the live room task, wherein the task information comprises a task data indicator of the live room task and target live room data matching the task data indicator;
acquiring real-time live room data matching the task data indicator in the live room; and
determining a task processing status of the live room task according to the real-time live room data and the target live room data.

18. The non-transitory computer-readable storage medium according to claim 17, said determining the task processing status of the live room task according to the real-time live room data and the target live room data comprises:
acquiring a target task duration pre-configured for the live room task, and a real-time task duration of the live room task; and
determining the task processing status according to the target task duration, the real-time task duration, the real-time live room data and the target live room data.

19. The non-transitory computer-readable storage medium according to claim 18, wherein the task information comprises a plurality of task data indicators; and
said determining the task processing status according to the target task duration, the real-time task duration, the real-time live room data and the target live room data comprises:
determining that the task processing status is successful in a case where the real-time task duration of the live room task is not longer than the target task duration, and real-time live room data respectively matching individual task data indicators is not smaller than target live room data respectively matching the individual task data indicators; and/or
determining that the task processing status is in progress in a case where the real-time task duration of the live room task is not longer than the target task duration, and real-time live room data matching any task data indicator is smaller than target live room data matching the task data indicator.

20. The non-transitory computer-readable storage medium according to claim 19, further comprising:
acquiring a virtual resource corresponding to the live room task, and allocating the virtual resource to an anchor client of the live room in response to determining that the task processing status is successful.
